(19) United States
(12) Patent Application Publication
(10) Pub. No.: US 2023/0001339 A1
(43) Pub. Date: Jan. 5, 2023

(54) MASK COMPRISING REUSABLE SHELL AND FILTER INSERT

(71) Applicant: North Carolina State University, Raleigh, NC (US)

(72) Inventors: Behnam Pourdeyhimi, Cary, NC (US); Hooman Tafreshi, Cary, NC (US); Pierre Grondin, Mooresville, NC (US)

(21) Appl. No.: 17/852,792

(22) Filed: Jun. 29, 2022

Related U.S. Application Data
(60) Provisional application No. 63/216,648, filed on Jun. 30, 2021.

(51) Int. Cl. B01D 39/16; A41D 13/11; A62B 23/02

(52) U.S. Cl. CPC B01D 39/163; A41D 13/11; A62B 23/025; B01D 2239/0618; B01D 2239/0622; B01D 2239/0627; B01D 2239/0681

(57) ABSTRACT

The disclosure relates to a mask including a perforated exterior shell sized to cover the nose and mouth of a user and constructed of one or more fabric layers, and a removable multi-layer nonwoven fabric insert sized to cover the nose and mouth of a user and adapted for abutting contact with the exterior shell, the nonwoven fabric including a layer of a spunbond material and a layer of meltblown material adjacent to the layer of spunbond material.

### CROSS-REFERENCE TO RELATED APPLICATIONS

The present application is claims the benefit of and priority to U.S. Provisional Patent Application No. 63/216,648, filed Jun. 30, 2021, the disclosure of which is incorporated herein by reference in its entirety.

### FIELD OF THE INVENTION

The present invention relates to mask structures suitable for use in personal protective equipment.

### BACKGROUND OF THE INVENTION

Synthetic fibers are widely used in a number of diverse applications to provide stronger, thinner, and lighter weight products. Synthetic thermoplastic fibers are typically thermos-formable and thus are particularly attractive for the manufacture of nonwoven fabrics, either alone or in combination with other non-thermoplastic fibers (such as cotton, wool, and wood pulp, for example). Nonwoven fabrics, in turn, are widely used as components of a variety of articles, including without limitation absorbent personal care products, such as diapers, incontinence pads, feminine hygiene products, and the like; medical products, such as surgical drapes, sterile wraps, and the like; filtration devices; interlinings; wipes; furniture and bedding construction; apparel; insulation; packaging materials; and others.

The coronavirus (COVID-19) global pandemic has caused a global shortage of medical supplies, and in particular, a shortage of various forms of personal protective equipment (PPEs) used by first responders and healthcare providers. The most significant challenge in this domain is the shortage of facemasks.

There are various types of facemasks available on the market. The N95 or N99 masks are among are the most well-known, and are typically referred to as respirators. Surgical masks are also facemasks, but they have drastically different properties from respirators. N95 and N99 respirators and surgical masks are PPEs used to protect the wearer from airborne particles.

The N95 and N99 respirators are regulated by the Centers for Disease Control and Prevention (CDC), the National Institute for Occupational Safety and Health (NIOSH) and the Occupational Safety and Health Administration (OSHA) and must adhere to the strict performance guidelines established by these organizations. N95 and N99 respirator filters need to have a filtration efficiency of more than 95% of 0.3-micron particles tested at a flow rate of 85 liters per minute for the respirator and 32 L/min for flat sheets (if the face velocity is adequate for determining the efficiency in a respirator). It is desirable that the pressure drop across these masks be less than 60 Pascals for the base filter. When the actual mask is tested, the pressure drops can be much higher and can reach 100 to 200 Pascals or more depending on construction, surface area, and the properties of the meltblown filter used.

The technology used in almost all masks for filtration is a polypropylene (PP) meltblown fabric that is electrostatically charged. A nonwoven filter medium that uses a combination of mechanical structure and electret charge provides a means of achieving high initial efficiency and sustained high efficiency. Meltblown PP fabrics are rather fragile and cannot be reused, laundered, or re-sterilized due to potential loss of charge and structural damage. They are often protected by layers of PP spunbond nonwovens made up of larger fibers that protect the meltblown filter layer.

There is a continuing need for improved types of filtration material for use in making personal protective equipment, as well as improved mask designs that afford durability and ease of use.

### SUMMARY OF THE INVENTION

The disclosure provides a mask configured to cover the nose and mouth of a user, the mask including a breathable, perforated exterior shell and a removable/disposable filter insert comprising a multi-layer nonwoven fabric. In some embodiments, the mask of the present disclosure combines strong filtration efficiency performance with relatively low pressure drop levels, and offers a construction that is less complex than many conventional masks. The exterior shell is typically designed to be washable and reusable and the filter insert is typically designed to be replaceable.

The disclosure includes, without limitation, the following embodiments.

Embodiment 1: A mask comprising a perforated exterior shell sized to cover the nose and mouth of a user and constructed of one or more fabric layers, and a removable multi-layer nonwoven fabric insert sized to cover the nose and mouth of a user and adapted for abutting contact with the exterior shell, the nonwoven fabric comprising a layer of a spunbond material and a layer of meltblown material adjacent to the layer of spunbond material.

Embodiment 2: The mask of Embodiment 1, wherein the nonwoven fabric further comprises a second layer of spunbond material adjacent to the layer of meltblown material on an opposing side thereof.

Embodiment 3: The mask of Embodiment 1 or 2, wherein one or both of the layers of spunbond material comprise at least partially fibrillated bicomponent filaments formed from bicomponent filaments having an external fiber component and an internal fiber component, wherein the external fiber component at least partially enwraps the internal fiber component, and wherein the external fiber component is 5% to 25 wt. % of the bicomponent filament.

Embodiment 4: The mask of any one of Embodiments 1-3, wherein the internal fiber component and the external fiber component comprise different thermoplastic polymers selected from the list consisting of polyesters, polyamides, thermoplastic copolyetherester elastomers, polyolefins, polyacrylates, and thermoplastic liquid crystalline polymers.

Embodiment 5: The mask of any one of Embodiments 1-4, wherein the internal fiber component comprises a polyolefin such as polypropylene (PP) or polyethylene (PE) and the external fiber component comprises a polyester such as polylactic acid (PLA) or polyethylene terephthalate (PET), or the internal fiber component comprises a polyester such as polylactic acid (PLA) or polyethylene terephthalate (PET), and the external fiber component comprises a polyolefin such as polypropylene (PP) or polyethylene (PE).

Embodiment 6: The mask of any one of Embodiments 1-5, wherein each layer of spunbond material has a basis weight of about 20 to about 150 gsm and the mask has a combined spunbond basis weight of about 50 gsm or greater.

Embodiment 7: The mask of any one of Embodiments 1-6, wherein each layer of spunbond material has a basis weight of about 30 to about 120 gsm and the mask has a combined spunbond basis weight of about 100 gsm or greater.

Embodiment 8: The mask any one of Embodiments 1-7, wherein the layer of meltblown nonwoven material has a basis weight of about 50 gsm or less.

Embodiment 9: The mask of any one of Embodiments 1-8, wherein the multi-layer nonwoven fabric has no more than three layers of nonwoven material.

Embodiment 10: The mask of any one of Embodiments 1-9, wherein the multi-layer nonwoven fabric consists of two layers of the spunbond material, each layer of spunbond material having a basis weight of about 20 to about 120 gsm, and a layer of meltblown nonwoven material having a basis weight of about 50 gsm or less.

Embodiment 11: The mask of any one of Embodiments 1-10, wherein the layer of spunbond material is in abutting contact with the perforated exterior shell.

Embodiment 12: The mask of any one of Embodiments 1-11, wherein the perforated exterior shell comprises two or more fabric layers affixed together.

Embodiment 13: The mask of any one of Embodiments 1-12, wherein the perforated exterior shell comprises two fabric layers adhered together with a meltblown layer therebetween.

Embodiment 14: The mask of any one of Embodiments 1-13, wherein the perforated exterior shell comprises one or more layers of a woven or knitted fabric.

Embodiment 15: The mask of any one of Embodiments 1-14, wherein the perforations of the perforated exterior shell comprise about 4% or greater of the surface area of the perforated exterior shell.

Embodiment 16: The mask of any one of Embodiments 1-15, wherein the perforations of the perforated exterior shell comprise up to about 30% of the surface area of the perforated exterior shell.

Embodiment 17: The mask of any one of Embodiments 1-16, wherein the mask has a filtration efficiency of about 95% or higher, measured according to the test set forth in 42 CFR Part 84 and NIOSH Procedure No. TEB-APR-STP-0059 at a face velocity of 10 cm/s.

Embodiment 18: The mask of any one of Embodiments 1-17, wherein the mask has an initial pressure drop in the range of about 150 Pa or less (or about 120 Pa or about 100 Pa or less or about 90 Pa or less) measured according to the test set forth in 42 CFR Part 84 and NIOSH Procedure No. TEB-APR-STP-0059 at a face velocity of 10 cm/s.

Embodiment 19: The mask of any one of Embodiments 1-18, wherein any layer of the spunbond material further comprises monocomponent fibers mixed therein, such as monocomponent polyolefin fibers (e.g., polyethylene or polypropylene).

Embodiment 20: The mask of any one of Embodiments 1-19, wherein the perforated exterior shell is washable and reusable.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this brief summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### DESCRIPTION OF THE DRAWINGS

Having thus described the present disclosure in general terms, reference will now be made to the accompanying drawings, which are not necessarily drawn to scale, and wherein:

FIG. 1 is a perspective view of an example embodiment of a fold-flat mask according to the disclosure showing the exterior shell and the filter insert;

FIG. 2 is a side view of an example embodiment of a fold-flat mask according to the disclosure showing a head strap with cord lock attached through the loops of the exterior shell;

FIG. 3 is a side view of an example embodiment of a fold-flat replaceable filter insert according to the disclosure;

FIG. 4 is a side view of an example embodiment of a fold-flat exterior shell for a mask according to the disclosure;

FIG. 5 is a cross-sectional view of a multi-layer example embodiment of a nonwoven material according to the disclosure;

FIG. 6 shows an islands-in the sea bicomponent fiber;

FIG. 7 depicts a typical bicomponent spunbonding process;

FIG. 8 shows a typical process for hydroentangling;

FIG. 9 is a schematic drawing of a typical meltblowing process;

FIG. 10 is a cross-sectional view of an example embodiment of a multi-layer fabric shell material according to the disclosure;

FIG. 11 is a scanning electron microscope (SEM) image with magnification at 50× for the S100 spunbond sample from Example 1; and

FIG. 12 is a scanning electron microscope (SEM) image with magnification at 50× for the M25 meltblown sample from Example 1.

### DETAILED DESCRIPTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise. Directional terms, such as “forward,” “rearward,” “front,” “back,” “right,” “left,” “upwardly,” “downwardly,” and the like are words of convenience and are not to be construed as limiting terms.

As used herein, the term “fiber” is defined as a basic element of nonwovens which has a high aspect ratio of, for example, at least about 100 times. In addition, “filaments/continuous filaments” are continuous fibers of extremely long lengths that possess a very high aspect ratio. “Staple fibers” are cut lengths from continuous filaments. Therefore, as used herein, the term “fiber” is intended to include fibers, filaments, continuous filaments, staple fibers, and the like. The term “multicomponent fibers” refers to fibers that comprise two or more components that are different by physical or chemical nature, including bicomponent fibers.

The term “nonwoven” as used herein in reference to fibrous materials, webs, mats, batts, or sheets refers to fibrous structures in which fibers are aligned in an undefined or random orientation. The nonwoven fibers are initially presented as unbound fibers or filaments, which may be natural or man-made. An important step in the manufacturing of nonwovens involves binding the various fibers or filaments together. The manner in which the fibers or filaments are bound can vary, and include thermal, mechanical and chemical techniques that are selected in part based on the desired characteristics of the final product. Nonwoven fabrics or webs have been formed from many processes, which include carding, meltblowing, spunbonding, and air or wet laying processes.

As used herein, the terms “hydroentangle” or “hydroentangling” refers to a process by which a high velocity water jet or even an air jet is forced through a web of fibers causing them to become randomly entangled. Hydroentanglement can also be used to impart images, patterns, or other surface effects to a nonwoven fabric by, for example, hydroentangling the fibers on a three-dimensional image transfer device such as that disclosed in U.S. Pat. No. 5,098,764 to Bassett et al. or a foraminous member such as that disclosed in U.S. Pat. No. 5,895,623 to Trokhan et al., both fully incorporated herein by reference for their teachings of hydroentanglement.

### Mask Structures

The present disclosure provides mask structures comprising an exterior shell, which is typically washable and reusable, and a filter insert, which is typically a multi-layer nonwoven material adapted for abutting contact on the interior (i.e., towards the face) side of the exterior shell. Typically, a mask according to this aspect of the disclosure will be configured to cover the mouth and nose of a user, and will include one or more bands (typically elastomeric) to temporarily affix the mask to the head of the user. These bands typically encircle the head or encircle the ears of the user. The mask structures of the present disclosure can take various forms, such as a fold-flat mask, which typically fits snugly across the face without significant spacing, or a duckbill mask, which protrudes away from the nose and mouth to create a breathing chamber between the mask and the face. Although a fold-flat mask is described in greater detail herein, the same general mask structure described herein could be used in other forms, including as a duckbill mask.

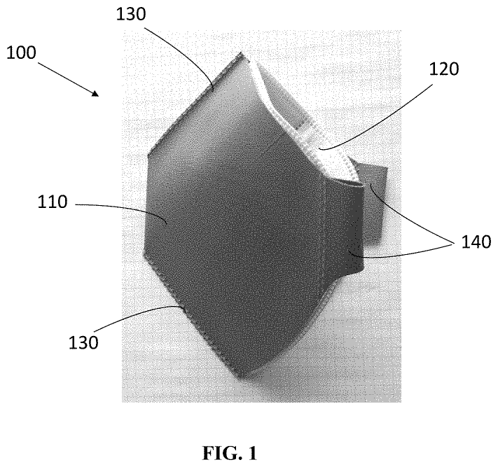

FIG. 1 illustrates a perspective view of a fold-flat mask structure 100 according to one embodiment that can include an exterior shell 110 and an internal filter insert 120. As shown, the exterior shell 110 can include various stitched seams 130 and a loop 140 on each opposing side for attachment of a head strap.

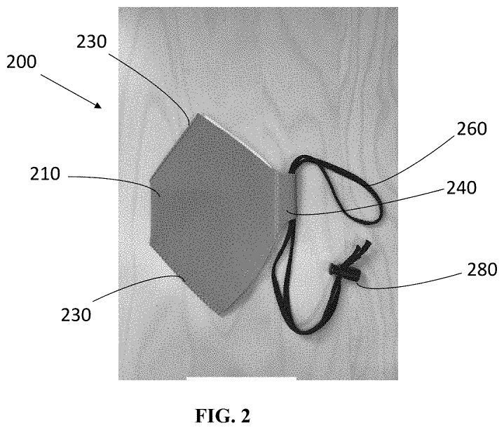

FIG. 2 illustrates a side view fold-flat mask structure 200 showing the exterior shell 210 with seams 230 and loop 240 as noted with respect to FIG. 1, and also showing an elastic head strap 260 engaged with the loops. The elastic head strap 260 has a cord lock 280 engaged therewith, thereby producing an adjustable head strap adapted to encircle the head with two separate loops of the elastic material.

As explained more fully below, the filter insert 120 is typically constructed of a multi-layer nonwoven material that includes at least one layer of spunbond nonwoven material and at least one layer of meltblown material. In an example embodiment, the nonwoven material is a multi-layer structure comprising two layers of the spunbond material of the present disclosure (e.g., each layer having a basis weight of about 150 gsm or less with a combined spunbond basis weight of about 50 gsm or higher), and a layer of meltblown material of the present disclosure (e.g., a meltblown having a basis weight of about 50 gsm or less) sandwiched between the spunbond material layers. One specific nonwoven material comprises a first spunbond layer having a basis weight of about 20 to about 50 gsm on a first side of the multi-layer structure intended for contact with the face of the user, a meltblown layer having a basis weight of about 20 to about 50 gsm adjacent to the first spunbond layer, and a second spunbond layer having a basis weight of about 80 to about 120 gsm adjacent to the opposing side of the meltblown layer (opposite the first spunbond layer) intended for contact with the exterior shell. The exterior shell 110 is typically constructed of a perforated fabric as explained more fully below.

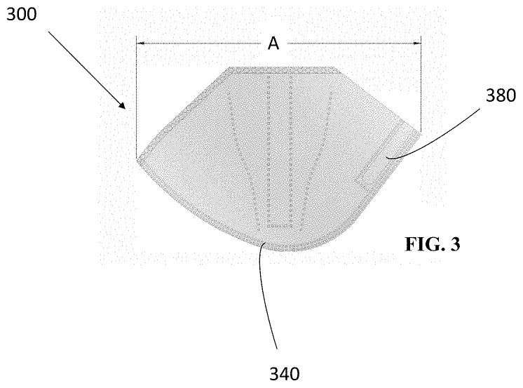

FIG. 3 is a side view of an example embodiment of the filter insert 300 for a fold-flat mask with the curved portion 340 being the openable side of the folded filter insert for accessing the interior of the filter insert that is intended to be placed against the face of the user. An optional nose wire 380 can be inserted within the multi-layer structure of the filter insert 300 as shown. Nose wires are typically constructed of plastic, metal, or combinations thereof. Example commercial sources include various products from Bedford Industries, Inc. (e.g., M5 or M8 nose wires). The filter insert 300 is typically free of any head strap for affixing the filter insert to the head of the user and is also typically free of any wire in the cheek area of the filter insert.

The filter insert 300 is sized to fit over the nose and mouth of the user and is typically sized to fit all or most users. If necessary, smaller or larger sizes could be utilized to accommodate very large or very small facial structures. Typically, the length of the filter insert 300 from the top edge covering the nose to the bottom edge positioned below the mouth (dimension A in FIG. 3) is in the range of about 10 to about 20 cm. The opposing width dimension (from tip of curved portion 340 to directly opposing side) for the filter insert 300 is typically in the range of about 5 to about 15 cm.

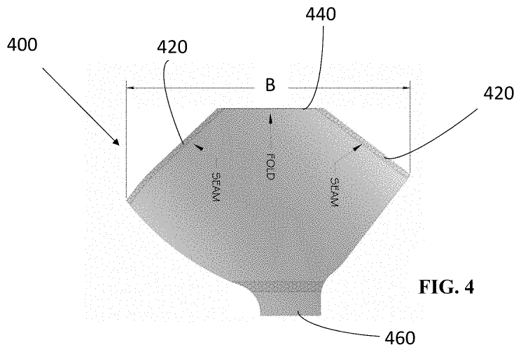

FIG. 4 is a side view of an example embodiment of the exterior shell 400 for a fold-flat mask showing seams 420, folded region 440, and loop 460. The side of the exterior shell 400 including loop 460 is the openable side of the folded shell for accessing the interior of the shell intended to be facing toward the filter insert and the face of the user. The exterior shell 400 is typically free of any nose wire and typically free of any wire in the cheek area of the shell.

The exterior shell 400 is sized to fit over the nose and mouth of the user and is typically sized to fit all or most users. If necessary, smaller or larger sizes could be utilized to accommodate very large or very small facial structures. Typically, the length of the shell 400 from the top edge covering the nose to the bottom edge positioned below the mouth (dimension B in FIG. 4) is in the range of about 12 to about 24 cm. The opposing width dimension (from folded region 440 to tip of loop 460) for the shell 400 is typically in the range of about 10 to about 20 cm.

The mask structures of the invention can serve as an N95 mask or N95 respirator, which is a particulate-filtering facepiece respirator that meets the U.S. National Institute for Occupational Safety and Health (NIOSH) N95 classification of air filtration, meaning that it filters at least 95% of airborne particles. Respirators have been categorized as being “filtering face-pieces” because the mask body itself functions as the filtering mechanism.

Certain embodiments of the mask structure of the disclosure including both the filter insert and the exterior shell have a filtration efficiency of about 80% or higher, or about 85% or higher or about 90% or higher or about 95% or higher or about 98% or higher or about 99% or higher (e.g., about 90% to about 99% or about 95% to about 99%), measuring according to the test set forth in the Experimental section herein. Example ranges of initial pressure drop during the loading test (NIOSH Procedure No. TEB-APR-STP-0059) for certain example embodiments of the mask structure of the disclosure including both the filter insert and the exterior shell include about 100 Pa or less or about 80 Pa or less or about 70 Pa or less or about 60 Pa or less, such as a range of about 40 to about 100 Pa or about 60 to about 90 Pa, measured at a face velocity of 10 cm/s.

### Nonwoven Fabric—Filter Insert

The fibers utilized to form the nonwoven fabrics of the present disclosure can vary, and include fibers having any type of cross-section, including, but not limited to, circular, rectangular, square, oval, triangular, and multilobal. In certain embodiments, the fibers can have one or more void spaces, wherein the void spaces can have, for example, circular, rectangular, square, oval, triangular, or multilobal cross-sections. The fibers may be selected from single-component or monocomponent (i.e., uniform in composition throughout the fiber) or multicomponent fiber types (e.g., bicomponent) including, but not limited to, fibers having a sheath/core structure and fibers having an islands-in-the-sea structure, as well as fibers having a side-by-side, segmented pie, segmented cross, segmented ribbon, or tipped multilobal cross-sections. In certain embodiments, the fabrics of the invention will include both monocomponent and multicomponent fibers, and will also typically include more than one type of polymer, either different grades of the same polymer or different polymer types. Nonwoven fabrics and methods for nonwoven production that can be adapted for use in the present disclosure are described in U.S. application Ser. No. 16/855,723 filed on Apr. 22, 2020, as well as in U.S. Pat. No. 7,981,226 to Pourdeyhimi et al.; U.S. Pat. No. 7,883,772 to Pourdeyhimi et al.; U.S. Pat. No. 7,981,336 to Pourdeyhimi, and U.S. Pat. No. 8,349,232 to Pourdeyhimi et al., all of which are incorporated by reference herein.

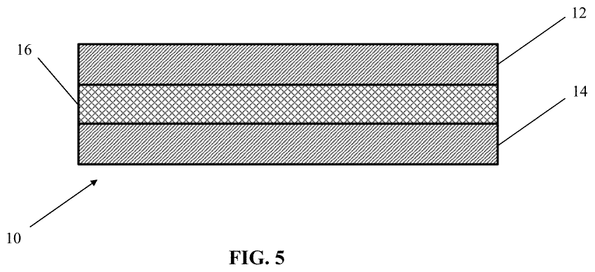

When used in a mask, in certain applications, the nonwoven material is used as part of a multi-layer structure. For example, an example multi-layer structure is shown in FIG. 5, which illustrates a nonwoven material 10 comprising an inner layer 16 sandwiched between two outer layers, 12 and 14. In certain embodiments of the present disclosure, the multi-layer nonwoven structure can include two layers or three layers, with example configurations including nonwovens with a spunbond layer and a meltblown layer, as well as nonwovens comprising two spunbond layers and a meltblown layer. In one advantageous embodiment, layers 12 and 14 in FIG. 5 are spunbond layers and layer 16 is a meltblown layer. Where multiple layers are utilized, the layers can be combined and affixed together using known techniques, such as through stitching or by means of thermal bonding, for example, ultrasonic welding.

Certain embodiments of the nonwoven fabric (i.e., the filter insert) have a filtration efficiency of about 80% or higher, or about 85% or higher or about 90% or higher or about 95% or higher or about 98% or higher or about 99% or higher (e.g., about 90% to about 99% or about 95% to about 99%), measuring according to the test set forth in the Experimental section herein. Example ranges of initial pressure drop during the loading test (NIOSH Procedure No. TEB-APR-STP-0059) for certain example embodiments of the nonwoven fabric include about 100 Pa or less or about 80 Pa or less or about 70 Pa or less or about 60 Pa or less, such as a range of about 30 to about 100 Pa or about 40 to about 80 Pa, measured at a face velocity of 10 cm/s.

### Spunbond Layer

The nonwoven fabric of the disclosure will typically include one or more layers of spunbond material comprising bicomponent fibers that have been partially or fully fibrillated. Such structures provide strong filtration efficiency performance at relatively low pressure drop levels. As used herein, “fibrillation” or “fibrillate” refer to at least partially breaking down a nonwoven web comprising the bicomponent fibers into fibrils through application of mechanical energy, resulting in at least partial separation and intertwining of the internal and external components of the bicomponent fibers. Confirmation of at least partial fibrillation of a nonwoven web of bicomponent fibers can be accomplished by visual inspection of Scanning Electron Microscopy (SEM) micrographs. Although not bound by a particular theory of operation, it is also believed that the fibrillation can impart a certain level of electrostatic charge to the nonwoven structure in certain embodiments, which may enhance filtration efficiency. Advantageously, certain embodiments of the spunbond nonwoven structure can be cut and sewn, which enables the use of a wider range of manufacturers to convert the nonwoven material into a mask structure. In addition, advantageous embodiments of the spunbond nonwoven material can be reused and re-sterilized by ozone, peroxide, and the like.

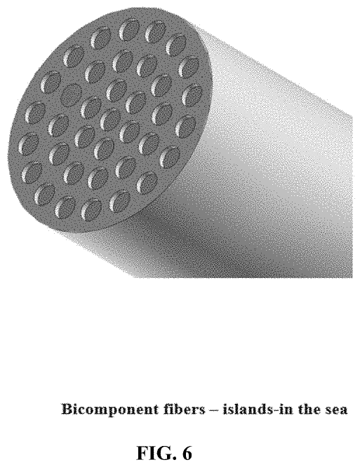

Prior to fibrillation, the bicomponent filaments include an external fiber component and an internal fiber component, wherein the external fiber component enwraps the internal fiber component. In some embodiments, the external fiber component only partially enwraps the internal fiber component, leaving at least part of the internal fiber component exposed. For example, the bicomponent fiber can be an islands-in-the-sea bicomponent filament having multiple internal fiber components and an external fiber component. FIG. 6 shows a typical islands-in-the-sea bicomponent filament. The “islands” internal fiber components are enwrapped in the “sea” external fiber component.

In certain embodiments, the bicomponent filament comprises an island-in-the-sea fiber having from 2 to about 1000 islands (internal components). In certain embodiments, the bicomponent filament has from about 5 to about 400 islands, such as from about 10 to about 200 islands or about 20 to about 100 islands or about 30 to about 40 islands.

In certain embodiments, the internal or external fiber component can comprise a thermoplastic polymer selected from the group consisting of polyesters, polyamides, thermoplastic copolyetherester elastomers, polyolefins, polyacrylates, and thermoplastic liquid crystalline polymers. In certain embodiments, the internal or external fiber component can comprise a thermoplastic polymer selected from the group consisting of nylon 6, nylon 6/6, nylon 6,6/6, nylon 6/10, nylon 6/11, nylon 6/12, nylon 11, nylon 12, polypropylene or polyethylene, polyesters, co-polyesters or other similar thermoplastic polymers. It is desirable to have internal and external fiber components that are not compatible; that is, the two components have minimal affinity for bonding to or sticking to one another. Example bicomponent fibers include those comprising a polyester such as polylactic acid (PLA) or polyethylene terephthalate (PET) as the external or sea component and a polyolefin such as polypropylene (PP) or polyethylene (PE) as the internal or island component, or a polyolefin such as PP or PE as both the sea and the island compounds (e.g., a PP sea and PE islands).

During fibrillation, the external fiber component, or sea, is fractured. Thus, the sea component can remain in the finished nonwoven fabric instead of being removed by dissolving or other methods. Leaving the sea component in the finished nonwoven fabric has multiple advantages, including reducing the cost of production and being more environmentally sound because solvents are not needed to dissolve the sea.

The compatibility between the fiber components is measured by the chi factor (χ) or the solubility parameter of the two polymers used. At the temperatures at which the polymers are processed, there can be chemical interactions between the two polymers, which can affect the interface between the polymer components.

In the bicomponent filament, the external fiber component typically comprises from about 5%-30% by weight of the total fiber for ease of fibrillation. In some embodiments, the external component is less than about 20% by weight of the total fiber. In one embodiment, the external component is about 10% or about 15% by weight of the total fiber. In other embodiments, the external fiber component is about 5%-10%, 6%-10%, 7%-10%, 8%-10%, 9%-10%, 5%-15%, 6%-15%, 7%-15%, 8%-15%, 9%-15%, 10%-15%, 11%-15%, 12%-15%, 13%-15%, 14%-15%, 15%, 5%-25%, 10%-25%, 15%-25%, or 15%-30% by weight of the total fiber.

In certain embodiments, the external sea component does not entirely enwrap the internal islands components. In certain embodiments, for example when the sea component is less than 20% by weight of the total fiber, the sea forms a thin barrier between the islands due to the low amount of external sea component. This increases the ease of fibrillation. In certain embodiments, the sea enwraps the islands less than 90%. In certain embodiments, the sea enwraps the islands less than 75%, less than 70%, less than 65%, less than 60%, less than 55%, less than 50%, from 1% to 90%, 10% to 90%, 20% to 90%, 30% to 90%, 40% to 90%, 50% to 90%, 60% to 90%, 70% to 90%, or 80% to 90%.

The spunbond material can contain other components, such as monocomponent fibers intermixed with the bicomponent fibers as set forth, for example, in U.S. Pat. No. 7,981,336 to Pourdeyhimi, which is incorporated by reference herein.

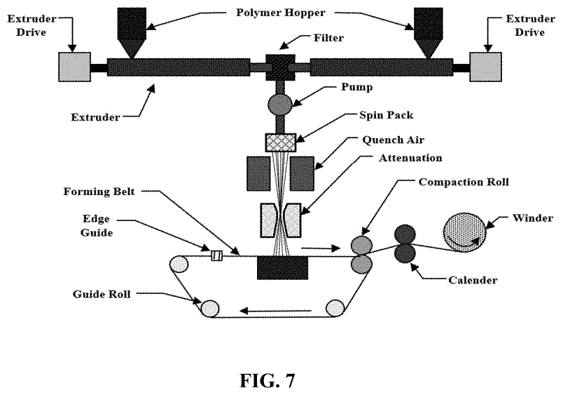

The bicomponent fibers, which typically have a filament size of between about 10 to about 100 microns, are formed into a nonwoven using a spunbonding process. FIG. 7 shows an example of a typical bicomponent filament spunbonding process. Polymer is fed from a hopper into an extruder. The polymer is heated in the extruder, melting the polymer. The polymer can be mixed with additives in the extruder. The molten polymer passes through a filter and into a pump. The polymer then moves into the spin pack which contains a spinneret. The spinneret has holes that form the molten polymer into fibers or filaments. Quench air cools the polymer, causing the polymer to solidify. In attenuation, the polymer filaments are stretched, orienting the molecules in the polymer.

In the exemplary process shown in FIG. 7, the polymer filaments are deposited on a forming belt to form a web. The web then passes through a compaction roll and a calender, which bonds the filaments together to form a fabric. Bonding methods used in spunbonding processes can include hydroentangling, needlepunching, thermal bonding, and other methods.

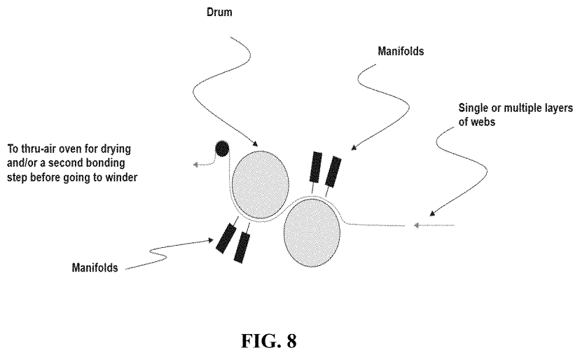

For purposes of the present disclosure, it is advantageous for the bonding process to include hydroentangling, which also causes fibrillation within the nonwoven web. FIG. 8 shows a typical process for hydroentangling. FIG. 8 shows a drum entangler using two drums and four injectors. A pre-wet injector/manifold may be used as well, and there may be more drums and injectors used. In some embodiments, the surface of the drum used in hydroentangling is smooth to enhance separation of the fibrils after fibrillation.

Typically, the fibrillation process utilizes hydro energy for fibrillating the external fiber component. The hydro energy used for fibrillation is also sufficient for hydroentangling the set of bicomponent filaments/fibers. The hydroentanglement process typically occurs after the bicomponent filaments/fibers have been positioned onto a belt carrier in the form of a web. The process produces micro-denier fibers which can be from 0.1 and 5 microns in diameter. In certain embodiments, the diameter is from 0.1 and 0.5 microns, 0.5 and 1 microns, 1 and 1.5 microns, 1.5 and 2 microns, 2 and 2.5 microns, 2.5 and 3 microns, 3 and 3.5 microns, 3.5 and 4 microns, 4 and 4.5 microns, 4.5 and 5 microns, 0.1 and 1 microns, 0.1 and 2 microns, 0.1 and 3 microns, 0.1 and 4 microns, 1 and 5 microns, 2 and 5 microns 3 and 5 microns, or 4 and 5 microns.

The web or the nonwoven fabric can be exposed to one or more hydroentangling manifolds to fibrillate and hydroentangle the fiber components. The web or nonwoven fabric can have a first surface and a second surface. In certain embodiments, the first surface is exposed to water pressure from one or more hydroentangling manifolds. In other embodiments, the first surface and second surface are exposed to water pressure from one or more hydroentangling manifolds. The one or more hydroentangling manifolds can have a water pressure from 10 bars to 1000 bars. Example water pressure used for hydroentanglement can be from 10 bars and 500 bars. In certain embodiments, the water pressure used for hydroentanglement is from 10 bars to 100 bars, 10 bars to 200 bars, 10 bars to 300 bars, 10 bars to 400 bars, 10 bars to 600 bars, 100 bars to 200 bars, 300 bars to 400 bars, 500 bars to 600 bars, 600 bars to 700 bars, 700 bars to 800 bars, 800 bars to 900 bars, 900 bars to 1000 bars, or 500 bars to 1000 bars. In certain embodiments, the water pressure used for hydroentanglement is from 10 bars to 300 bars. In additional embodiments, a series of injectors or manifolds are used, and the pressure is gradually increased.

In certain embodiments, the hydroentangling manifold water jets are spaced at least 1200 microns away from each other. In some other examples, the water jets are spaced from 1200 microns to 4800 microns apart, e.g., from 1200 microns to 1800 microns, 1200 microns to 2400 microns, 1800 microns to 2400 microns, 1800 microns to 2400 microns, or 2400 microns to 4800 microns apart. Each water jet spacing pertains to one manifold. In certain embodiments, for the disclosed method, 3, 4, 5, or 6 manifolds can be used. In other embodiments, more than 6 manifolds can be used.

In some embodiments, hydroentangling can use multiple manifolds where the spacing of the water jets increases or decreases from the first manifold or set of manifolds to the last manifold or set of manifolds. For example, at least 3 manifolds can have jet spacings of at least 1200 microns, where the rest are below 1200 microns. In other embodiments, at least 4, 5, or 6 manifolds can have jets at least 1200 microns apart where the rest are below 1200 microns. In some other embodiments, at least 3, 4, or 5 manifolds can have jet spaced at least 2400 microns apart where the rest are less than 2400 microns apart. In additional embodiments, 6 manifolds can be used with at least three of the water jets being spaced 1200 microns apart, at least two of the water jets being spaced at least 2400 microns apart, and at least one of the water jets being spaced 600 microns apart. In other embodiments, 5 manifolds can be used with at least two of the water jets being spaced 1200 um apart, at least two of the water jets being spaced at least 2400 um apart, and at least one of the water jets being spaced 600 microns apart. In yet other embodiments, 4 manifolds can be used with at least two of the water jets being spaced 1200 um apart and at least two of the water jets being spaced at least 2400 microns apart. In further embodiments, 3 manifolds can be used with at least two of the water jets being spaced 1200 microns apart. This spacing of the manifold jet strips can lead to partial fibrillation of the bicomponent filaments/fibers. The partial fibrillation allows for a low-density material with a low pressure drop while keeping a high efficiency. The structure of the material is made up of fine fibrils and larger fibers. Partial fibrillation can result, for example, in about 50% of the fibers being fibrillated. This can be determined by SEM micrographs. In some examples, from 80% to 10% of the fibers are fibrillated, e.g., 70%, 60%, 50%, 40%, 30%, 20%, or 10%, where any value can form the upper or lower endpoint of a range, can be fibrillated as determined by SEM micrographs.

By at least partially fibrillating the external fiber component, a spunbond nonwoven fabric comprising microfibers or nanofibers can be produced which can be used for construction of masks as set forth in greater detail below. In certain embodiments, the thickness of the spunbond fabric that results from this disclosed method can be from 1 to 2 mm, e.g., from 1 mm to 1.2 mm, from 1 mm to 1.4 mm, from 1.4 mm to 1.6 mm, from 1.4 mm to 1.8 mm, or 1.4 mm to 2 mm.

In some embodiments, the basis weight of the spunbond nonwoven web used in each spunbond layer is about 200 g/m² or less, about 175 g/m² or less, about 150 g/m² or less, about 125 g/m² or less, about 100 g/m² or less, or about 75 g/m² or less. In certain embodiments, the spunbond nonwoven fabric used in each spunbond layer has a basis weight of about 20 g/m² to about 200 g/m², such as about 30 to about 150 g/m². In certain embodiments, multiple spunbond layers are used in the nonwoven structure, with a total spunbond layer basis weight of about 60 g/m² or greater, about 75 g/m² or greater, about 100 g/m² or greater, or about 120 g/m² or greater. The basis weight of the fabric can be measured, for example, using test methods outlined in ASTM D 3776/D 3776M-09ae2 entitled “Standard Test Method for Mass Per Unit Area (Weight) of Fabric.” This test reports a measure of mass per unit area and is measured and expressed as grams per square meter (i.e., gsm or g/m²).

It has been surprisingly discovered that use of a partially fibrillated spunbond layer in the mask structure of the present disclosure can enhance the ability of the filter insert to remain in place against the exterior shell. Without being bound by a theory of operation, it is believed that a partially fibrillated spunbond layer as described herein has a surface roughness conducive for mechanical engagement with the surface of the exterior shell, making such a material an advantageous choice as the outer layer of the filter insert intended for abutting contact with the exterior shell. In certain embodiments, the partially fibrillated spunbond layer is positioned such that the layer contacts the interior side of the exterior shell, and the spunbond layer has a basis weight of about 50 gsm or higher, or about 75 gsm or higher, or about 85 gsm or higher (e.g., about 50 to about 150 gsm or about 75 to about 125 gsm or about 80 to about 120 gsm). In certain embodiments, this spunbond layer comprises at least partially fibrillated bicomponent filaments formed from bicomponent filaments having an external fiber component and an internal fiber component, wherein the external fiber component at least partially enwraps the internal fiber component, and wherein the external fiber component is 5% to 25 wt. % of the bicomponent filament, with example polymer combinations including an internal fiber component comprises a polyolefin such as polypropylene (PP) and the external fiber component comprises a polyester such as polylactic acid (PLA) or polyethylene terephthalate (PET).

In certain embodiments where two opposing spunbond layers are used, one on each side of a meltblown layer, the other spunbond layer (not facing the exterior shell) is primarily used to protect the meltblown layer. This spunbond layer does not have to a partially fibrillated bicomponent fibers and can, instead, comprise monocomponent fibers, such as polyolefin fibers (e.g., polyethylene or polypropylene) having a basis weight lower than the opposing spunbond layer, such as about 50 gsm or less, or about 40 gsm or less (e.g., about 15 to about 50 gsm or about 20 to about 40 gsm). In other embodiments with two opposing spunbond layers, partially fibrillated bicomponent fibers can be used in both layers, which will enhance the filtration efficiency of the overall nonwoven structure.

### Meltblown Layer

In certain embodiments, the nonwoven fabrics of the present disclosure can include a meltblown layer. For example, the meltblown layer could comprise a thermoplastic polymer selected from the group consisting of polyesters, polyamides, thermoplastic copolyetherester elastomers, polyolefins, polyacrylates, and thermoplastic liquid crystalline polymers. In certain embodiments, the meltblown layer can comprise a thermoplastic polymer selected from the group consisting of nylon 6, nylon 6/6, nylon 6,6/6, nylon 6/10, nylon 6/11, nylon 6/12, nylon 11, nylon 12, polypropylene or polyethylene, polyesters, co-polyesters or other similar thermoplastic polymers. Certain advantageous embodiments of the meltblown material comprise polypropylene.

Fibers used in meltblown layer of the present disclosure can also include an elastomeric component. “Elastomer” and “elastomeric component,” as used herein, refer to any polymer that exhibits a degree of elasticity (e.g., capable of returning substantially to its original shape or form after being subjected to stretching or deformation).

Although not limited, the elastomers used in the present disclosure typically are thermoplastic elastomers (TPEs), which generally exhibit some degree of elasticity and can be processed via thermoplastic processing methods (e.g., can be easily reprocessed and remolded). Thermoplastic elastomers can comprise both crystalline (i.e., “hard”) and amorphous (i.e., “soft”) domains and often comprise a blend or copolymer of two or more polymer types. Where the thermoplastic elastomer comprises a copolymer, it may be prepared, for example, by block or graft polymerization techniques. Thermoplastic elastomeric copolymers can, for example, comprise a thermoplastic component and an elastomeric component. In certain copolymeric thermoplastic elastomers, the physical properties of the material can be controlled by varying the ratio of the monomers and/or the lengths of the segments.

Certain exemplary thermoplastic elastomers can be classified as styrenic elastomers (e.g., styrene block copolymers), polyester and copolyester elastomers, polyurethane elastomers, polyamide elastomers, polyolefin blends (TPOs), polyolefins (alloys, plastomers, and elastomers including metallocene polyolefin elastomers), ethylene vinyl acetate elastomers, and thermoplastic vulcanizates. Certain specific elastomers that are useful according to the present invention include, for example, polyisoprene, butadiene rubber, styrene-butadiene rubber, poly(styrene-b-butadiene-b-styrene) (SBS), poly(styrene-b-ethene-co-butane-b-styrene (SEBS), poly(styrene-b-isoprene-b-styrene), ethylene propylene diene monomer rubber (EPDM rubber), EPDM rubber/polypropylene (EPDM/PP), polychloroprene, acrylonitrile-butadiene rubber, hydrogenated nitrile rubber, butyl rubber, ethylene-propylene rubber (EPM), silicone rubber, chlorosulfonated polyethylene, polyacrylate rubber, fluorocarbon rubber, chlorinated polyethylene rubber, epichlorohydrin rubber, ethylene-vinylacetate copolymer, styrene-isoprene block copolymer, urethane rubber, and copolymers, blends, and derivatives thereof.

Exemplary commercially available thermoplastic elastomers include, but are not limited to, OnFlex™, Versaflex™, Dynaflex™, Dynalloy™, Versalloy™, and Versollan™ from PolyOne™ Corporation (Avon Lake, Ohio); RTP 1200, 1500, 2700, 2800, 2900, and 6000 Series Elastomers from RTP Company (Winona, Minn.); Elastocon 2800, 8000, STK, SMR, CLR, and OF Series TPEs from Elastocon (Rochester, Ill.); Enflex® and Ensoft® from Enplast (Turkey); Styroflex® SBS, Elastollan®, and Elasturan® from BASF (Florham Park, N.J.); Kraton MD6705, G1643, MD6717, MD6705, G1643 (Kraton Performance Polymers, Inc., Houston, Tex.); Affinity™, Amplify™, Engage™, Infuse™, Nordel™, and Versify™ from Dow Chemical (Midland, Mich.); Vistamaxx™, Santoprene™, and Exact™ from ExxonMobil Chemical Company (Houston, Tex.); Kalrez®, Neoprene, Hytrel®, Surlyn®, Vamac®, and Viton® from DuPont® Chemicals (Wilmington, Del.); Pebax® from Arkema (France); Mediprene® and Dryflex® from Elasto (Sweden); Estagrip® and Estane® from Lubrizol Corporation (Wickliffe, Ohio); Garaflex™, Garathane™, Vythrene™, and Evoprene™ from AlphaGary (Leominster, Mass.) and Santoprene® from Advanced Elastomer Systems (Newport, Calif.). Other exemplary elastomeric materials are described, for example, in US2010/0029161 to Pourdeyhimi, which is incorporated herein by reference; see also, U.S. Pat. No. 5,035,240 to Braun et al. and U.S. Pat. No. 5,540,976 to Shawver et al., and Zapletalova et al., Polyether Based Thermoplastic Polyurethane Melt Blown Nonwovens, Journal of Engineered Fibers and Fabrics, Vol. 1, Issue 1 (2006), which are incorporated herein by reference.

In certain embodiments, the elastomer is a thermoplastic elastomer (TPE), such as a thermoplastic polyurethane elastomer (TPU) or thermoplastic polyester elastomer (TPE-ET). A particularly advantageous TPE-ET is a series of polymers sold under the Hytrel® trade name by DuPont (Wilmington, Del.), which are block copolymers consisting of hard crystalline segments of polybutylene terephthalate and soft amorphous segments based on long-chain polyether glycols. Properties of various HYTREL grades are determined by the ratio of hard to soft segments. Particularly advantageous grades of TPE-ET, such as HYTREL, for use in the present disclosure have a shore D hardness in the range of about 45 to about 65D (tested according to ISO 868), such as about 50D to about 60D, and a flexural modulus at 23° C. of about 125 MPa to about 350 MPa (tested according to ISO 178), such as about 150 to about 250 MPa.

In certain embodiments, the elastomer can be used in a blend with one or more additional polymers. In such embodiments, it is advantageous for the blend to be at least 90% by weight of the elastomer, such as at least about 95% by weight elastomer. Example blending partners include polyesters, co-polyesters, polyamides, polyolefins, polyacrylates, or thermoplastic liquid crystalline polymers. Specific examples include biodegradable polymers such as polybutylene succinate (PBS), poly(butylene succinate)-co-(butylene carbonate) (PBS-co-BC), polyethylene carbonate (PEC), polyhydroxyalkanoates (PHA) such as polyhydroxybutyrate (PHB), poly(glycolic acid) (PGA), polycaprolactone (PCL), and combinations thereof. In certain advantageous embodiments, the blending partner is a polyolefin, such as polypropylene. The use of a blending partner can be particularly convenient when the blending partner is commercially available as a masterbatch with a desired additive for the nonwoven material, such as charge stabilizers discussed below.

Meltblowing is a process wherein a polymer (or polymers) is melted to a liquid state and extruded through a linear die containing numerous (e.g., several hundred or more) small orifices. As the polymer is extruded, streams of hot air are rapidly blown at the polymer, rapidly stretching and/or attenuating the extruded polymer streams to form extremely fine filaments. The air streams typically stretch or attenuate the molten polymer by many orders of magnitude. The stretched polymer fibers are collected as a randomly entangled, self-bonded nonwoven web. Meltblowing generally is described, for example, in U.S. Pat. No. 3,849,241 to Butin, which is incorporated herein by reference.

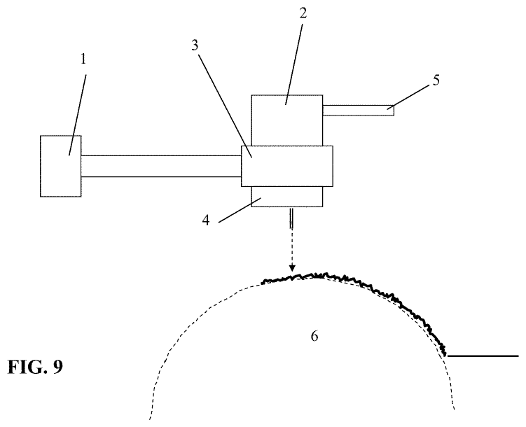

As illustrated in FIG. 9, for example, a high-velocity gas jet impinges upon the polymer as it emerges from the spinneret 4. An extruder 1 can feed a polymer to a first die 3 and through spinneret 4. Air enters from air intake 5 and into the air manifold 2. High pressure air is then used to draw the polymer into a fiber which can be collected on collector 6. The drag force caused by the air attenuates the fiber rapidly, and reduces its diameter as much as a hundred times from the nozzle diameter. Melt blown webs are typically reported to have fibers in the range of 0.1-10 μm, high surface area per unit weight, high insulation value, self-bonding, and high barrier properties yet breathability.

Meltblowing is generally capable of providing fibers with relatively small diameters. Diameter and other properties of meltblown fibers can be tailored by modifying various process parameters (e.g., die design, die capillary size, polymer throughput, air velocity, collector distance, and web handling). Attenuating the air pressure affects fiber size, as higher pressures typically yield finer fibers (e.g., up to about 5 microns, such as about 1-5 microns) and lower pressures yield coarser fibers (e.g., up to about 20 microns, such as about 10-20 microns). In certain embodiments, the nonwoven web comprises meltblown fibers having average diameters of about 20 microns or less, such as about 15 microns or less or about 10 microns or less or about 5 microns or less (e.g., about 1 to about 10 microns or about 1 to about 5 microns in average diameter). By meltblown standards, the use of a relatively large fiber, such as the ranges provided above, can improve breathability of the resulting fabric.

The design of the meltblowing dies can vary. A conventional Exxon-design meltblown technology (i.e., single-row-capillary or impinging-air type die design) has a single row of spinning capillaries with impinging air streams from both sides of the die tip to draw the fibers. The safe operation pressure of this process is less than about 100 bar, for example. The Biax meltblown die technology (i.e., concentric-air design) features multiple rows of spinning nozzles with individual concentric air jets to attenuate the fibers. It also tolerates high melt pressures at the spinneret and therefore can utilize higher viscosity polymers with a wide operation window. See, e.g., R. Zhao, “Melt Blowing Polyoxymethylene Copolymer,” International Nonwoven Journal, Summer 2005, pp. 19-21 (2005), herein incorporated by reference.

After production of the fibers and deposition of the fibers onto a surface, the meltblown nonwoven web can, in some embodiments, be subjected to some type of bonding (including, but not limited to, thermal fusion or bonding, mechanical entanglement, chemical adhesive, or a combination thereof), although in some embodiments, the web preparation process itself provides the necessary bonding and no further treatment is used. In one embodiment, the nonwoven web is bonded thermally using a calendar or a thru-air oven. In other embodiments, the nonwoven web is subjected to hydroentangling, which is a mechanism used to entangle and bond fibers using hydrodynamic forces. For example, the fibers can be hydroentangled by exposing the nonwoven web to water pressure from one or more hydroentangling manifolds at a water pressure in the range of about 10 bar to about 1000 bar.

The fibrous webs thus produced can have varying thicknesses. The process parameters can be modified to vary the thickness. For example, in some embodiments, increasing the speed of the moving belt onto which fibers are deposited results in a thinner web. Average thicknesses of the nonwoven webs can vary and, in some embodiments, the web may have an average thickness of about 1 mm or less.

The stiffness of the meltblown structure for a given polymer can be controlled by employing larger diameter fibers and/or a higher basis weight. In some embodiments, the basis weight of the meltblown nonwoven web is about 100 g/m² or less, about 75 g/m² or less, about 65 g/m² or less, about 60 g/m² or less, about 50 g/m² or less, or about 40 g/m² or less. In certain embodiments, the meltblown nonwoven fabric has a basis weight of about 20 g/m² to about 60 g/m², such as about 20 to about 50 g/m² or about 25 to about 35 g/m².

### Fiber Additives

In certain embodiments, the nonwoven fabrics of the present disclosure, or portions or layers thereof, are electrostatically charged. Due to conductivity within the material and ionic attacks from the environment, it is possible that this charge will decay after a period of time, which can lead to reduction of filtration efficiency. Accordingly, in certain embodiments, one or more charge stabilizer additives adapted to increase filtration efficiency and enhance longevity of the surface charge of the fabric can be added to one or of the polymers that form the nonwoven material. Example additives include metal salts of fatty acids such as stearic acid (e.g., magnesium, zinc, or aluminum stearate), titanate salts such as alkaline earth metal titanate salts (e.g., barium titanate or perovskite), silicate salts such as tourmaline, and other mineral materials such as perlite. When present, the amount of this type of additive is typically in the range of less than about 10% by weight of the overall fiber composition, such as less than about 7.5% or less than about 5% (e.g., about 0.1 to about 10% by weight or about 0.1 to about 5% by weight).

The polymer composition used to form any of the nonwoven materials noted herein can optionally include other components not adversely affecting the desired properties thereof. Examples include, without limitation, antioxidants, particulates, pigments, and the like. These and other additives can be used in conventional amounts.

### Optional Electrostatic Charging

The nonwoven web, or a portion or layer thereof, can be treated to induce an electrostatic charge within the fibrous material, which enhances filtration efficiency of the material. Electric charge can be imparted to the fibers by various methods including, but not limited to, corona charging, tribocharging, hydrocharging, and plasma fluorination. See, for example, the electric charging techniques set forth in U.S. Pat. No. 4,215,682 to Kubik et al.; U.S. Pat. No. 4,588,537 to Klasse et al.; U.S. Pat. No. 4,798,850 to Brown; U.S. Pat. No. 5,401,446 to Tsai et al.; U.S. Pat. No. 6,119,691 to Angadjivand et al.; and U.S. Pat. No. 6,397,458 to Jones et al., all of which are incorporated by reference herein. In one particular embodiment, the fibrous material is charged using corona charging by treating one or both sides of the nonwoven web with charging bars, such as those available from Simco-Ion, which can be placed close to the surface of the nonwoven web (e.g., about 20 to about 60 mm) and operating at a voltage of about 35 to about 50 kV. The treated nonwoven fabric is electrostatically charged following such treatment, and such materials are sometimes referred to as electret fibrous materials.

### Mask Exterior Shell

The exterior shell of the mask provides increased durability, rigidity, and strength to the mask structure. Typically, the exterior shell is designed to be washable and reusable, while the filter insert is intended to be disposable and replaceable. The exterior shell is constructed of a fabric material, such as a woven or knitted fabric, or a nonwoven material. To provide the necessary strength and rigidity, the exterior shell of the mask typically has an overall thickness of at least 0.5 mm, such about 1.0 mm to about 2.0 mm.

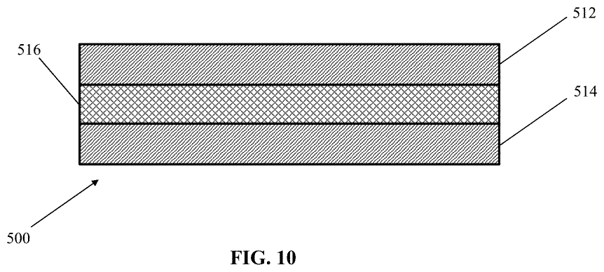

Many woven fabric materials suitable for use in the exterior shell are insufficiently rigid for use in a mask as a single layer. Without sufficient rigidity, a facial mask/respirator will deform significantly during inhalation and exhalation, which can degrade fit and comfort and possibly obstruct breathing. Accordingly, in certain advantageous embodiments, the exterior shell comprises two or more fabric layers (e.g., two or more woven or knitted layers) adhered or otherwise affixed together. It has been surprisingly discovered that a thin meltblown nonwoven layer between two fabric layers can greatly enhance the rigidity of the resulting structure, which improves the usefulness of such a structure as an exterior shell for a mask. An example embodiment of a multi-layer exterior shell 500 is shown in FIG. 10, which includes two layers 512 and 514 of, for example, a woven or knitted material, with a middle layer 516 of a meltblown material as an adhesive. Other adhesive materials could also be used as the middle or tie layer 516.

The exterior shell of a mask structure for use in the present disclosure must also have sufficient breathability to avoid greatly increasing the pressure drop of the mask. Multi-layer fabric structures of the type described above exhibit pressure drops far exceeding the range needed for use in face masks. However, it has been surprisingly discovered that perforating the exterior shell can greatly reduce the pressure drop associated with the shell, even at relatively low levels of perforation. For example, perforations in the exterior shell can comprise no more than about 30%, or no more than about 25%, or no more than about 20% of the surface area of the exterior shell. For example, perforations in the exterior shell can comprise about 4% or greater, about 6% or greater, about 8% or greater, or about 10% or greater of the surface area of the exterior shell. Example perforation surface area ranges include about 4% to about 30%, about 5% to about 25%, about 6% to about 20%, and about 8% to about 15%.

The dimensions of each perforation can vary, with an example range being about 0.1 mm to about 2 mm in diameter (e.g., about 0.5 to about 1.5 mm). The cross-sectional shape of the perforations is advantageously circular, but other cross-sections could be used without departing from the present disclosure (e.g., rectangular, triangular, oval, etc.). The perforations can be present in a uniform or non-uniform (or random) pattern in the exterior shell.

The exterior shell is typically constructed of a polymeric material including any of the fabric materials commonly used in apparel, such as nylon, cotton, polyester, elastomeric materials, and combinations or blends thereof, specifically including nylon/cotton blends and polyester/cotton blends. The mask exterior shell can be selected from, for example, military grade fabrics available from Milliken and Company, Elevate Textiles, or Invista.

Example ranges of initial pressure drop during the loading test (NIOSH Procedure No. TEB-APR-STP-0059) for certain embodiments of the perforated exterior shell include about 15 Pa or less, or about 10 Pa or less, or about 8 Pa or less (e.g., about 0.1 Pa to about 10 Pa or about 0.5 Pa to about 5 Pa or about 1 Pa to about 4 Pa), measured at a face velocity of 10 cm/s according to the test set forth in the Experimental section herein.

### EXPERIMENTAL

### Example 1: Nonwoven Preparation

### Spunbond Preparation

A spunbond web comprising bicomponent sheath-core PE/PP fibers with a basis weight of 35 gsm was produced. This was calendared with an elliptical bond pattern to a total bond area of ˜18% (referred to herein as S35 material). Alternatively, the structure could comprise a homocomponent structure made up of PP or PE.

A spunbond web comprising bicomponent islands-in-the-sea fibers having 37 PP islands and a PLA sea (85% PLA/15% PP by weight) was prepared. The spunbond web was partially fibrillated with water jets by using 7 injectors comprising hydroentangling jet strips with the jets spaced at 2400, 2400, 1200, 1200, 1200, 600 microns apart, with a pre-wet manifold having jets 1200 microns apart. The basis weight for the sample was 100 gsm (referred to herein as S100 material).

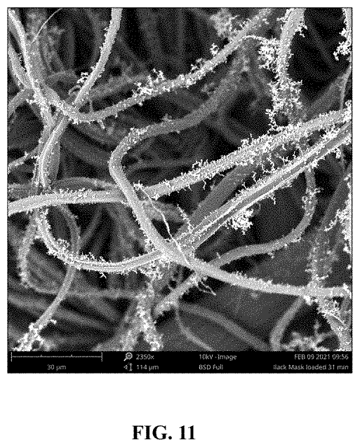

A scanning electron microscope (SEM) image with magnification at 50× is provided as FIG. 11 for the S100 spunbond material, which provides visual confirmation of the fibrillation.

### Meltblown Preparation

Several samples of PP meltblown nonwoven web were formed having a basis weight of 20, 25, and 30 gsm (referred to herein as M20, M25, and M30, respectively). The samples were produced on a Reicofil R4 meltblowing machine where the throughput was kept between 0.3 to 0.5 gram per hole per minute by using a meltblowing die with 20 to 75 holes per inch (300 micron capillary). The die to collector distance was kept constant at 225 mm. The air was from 1100 to 1500 m³/meter/hour.

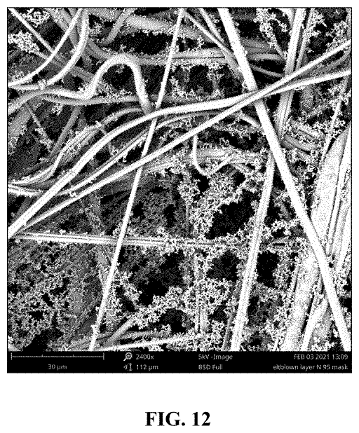

A scanning electron microscope (SEM) image with magnification at 50× is provided as FIG. 12 for the M25 meltblown material.

### Example 2: Filtration Efficiency/Pressure Drop Testing of Single Sheets

Samples from Example 1 were tested for filtration efficiency using a test set forth in 42 CFR Part 84 and NIOSH Procedure No. TEB-APR-STP-0059, which was conducted using a Model 8130 Automated Filter Tester manufactured by TSI Incorporated. The test involved challenging the nonwoven material with salt particles having a particle size distribution with count median diameter of 0.075±0.020 um and a standard geometric deviation not exceeding 1.86 in an aerosol at room temperature (about 25° C.) and a relative humidity of about 30%. The NaCl particles were neutralized and each tested material was challenged with a salt particle concentration of not more than 200 mg/m³.

The nonwoven materials were tested as flat sheets as opposed to testing after converting the nonwoven into a mask/respirator. The smallest respirator is 140-150 cm² in surface area and respirators are tested at 85 L/min, which translates to a face velocity of about 10 cm/s. The flat sheet area for the test is only 100 cm². Therefore, the testing was conducted at 60 L/min to achieve the same face velocity of 10 cm/s. Accordingly, it is believed that the data generated will correlate well to test data for masks made of the same material.

To be designated an N95 respirator, the minimum filtration efficiency achieved by this test must be 95%, and the filtration efficiency cannot fall below this level at any point during the entire loading test. The initial pressure drop was also recorded on the TSI 8130 machine for each material simultaneously.

Table 1 below presents the test data generated for the S35, S100, M20, and M30 materials from Example 1.

TABLE 1

| | | | Face | Pressure | |
|---|---|---|---|---|---|
| Materials- | | Weight | Velocity | Drop | Efficiency |
| Tested as sheets | Code | (gsm) | (cm/s) | (Pa) | (%) |
| Spunbond (PP/PE) | S35 | 35 | 6.0 | 8.7 | 17.63 |
| Spunbond (PLA/PP) | S100 | 100 | 6.0 | 11.5 | 74.82 |
| Meltblown | M30 | 30 | 6.0 | 54.3 | 99.30 |
| Meltblown | M20 | 20 | 6.0 | 34.6 | 98.87 |

As shown by the above data, the single layer sheets of meltblown material provide a high degree of particle filtration efficiency and a higher pressure drop. The spunbond layers provide lower particle filtration efficiency and pressure drop, and it is clear that the fibrillated PLA/PP structure offers a much higher efficiency compared to typical spunbond structures used to protect the meltblown filtration layer.

### Example 3: Filtration Efficiency/Pressure Drop Testing of Multi-Layer Structures

A series of flat sheets comprising multiple layers of spunbond material and meltblown material from Example 1 were tested using the same general testing protocol set forth in Example 2. Table 2 below provides the test data generated for various combinations.

TABLE 2

| | Face | Pressure | |
|---|---|---|---|
| Layers-Tested | Velocity | Drop | Efficiency |
| as stacked sheets | (cm/s) | (Pa) | (%) |
| S35-M20-S35 | 6.0 | 50.6 | 98.58 |
| S35-M20-S100 | 6.0 | 51.8 | 99.38 |
| S100-M20-S100 | 6.0 | 55.5 | 99.77 |
| S35-M25-S35 | 6.0 | 57.7 | 99.15 |
| S35-M25-S100 | 6.0 | 60.3 | 99.71 |
| S100-M25-S100 | 6.0 | 64.6 | 99.89 |
| S35-M30-S35 | 6.0 | 70.7 | 99.51 |
| S35-M30-S100 | 6.0 | 73.9 | 99.80 |
| S100-M30-S100 | 6.0 | 75.9 | 99.92 |

All of the noted configurations of Table 2 meet the qualifications of an N95 mask (i.e., maintained a filtration efficiency of 95% or greater throughout the test). This suggests that combinations of a meltblown material with a spunbond material in a layered configuration, and particularly at a total basis weight of 90 gsm or greater, can provide an effective N95 mask material. Some of the samples also meet the qualifications of an N99 mask (i.e., maintained a filtration efficiency of 99% or greater throughout the test). The above data demonstrate that these layered nonwoven structures would be suitable for use as a filter insert in a mask.

### Example 4: Filter Shell Testing

A woven polyester/cotton fabric available from Milliken (tan-colored, style 755917) was evaluated as an exterior shell material for a mask structure. It was determined that a single layer of the material was too flexible and would collapse with inhalation. Two layers of the material were laminated together with a lightweight 30 gsm meltblown material therebetween as an adhesive layer (HYTREL thermoplastic elastomer). The resulting structure was rigid and strong, but as expected, produced a pressure drop too high for use as a mask.

Samples of the above-noted laminate structure were perforated at different levels to reduce pressure drop: (1) Sample IPS 1.0 with 4.9% open area; (2) Sample IPS 1.1 with 20% open area; and (3) Sample IPS 3.0 with 30% open area. The base woven materials and perforated versions were tested for pressure drop and filtration efficiency using the same basic testing process as set forth in Example 2. Table 3 below provides the results.

TABLE 3

| | Velocity | Pressure | Eff. |
|---|---|---|---|
| Shell Details | (cm/s) | (Pa) | (%) |
| Shell | 6.0 | 11.2 | 7.6 |
| Single Layer | | | |
| Shell-Double Layer | 6.0 | 1476.3 | 91.6 |
| Laminated with | | | |
| Hytrel MB | | | |
| IPS 1.0 | 6.0 | 1.5 | 5.0 |
| 4.9% Open Area | | | |
| IPS 1.1 | 6.0 | 1.3 | 4.8 |
| 20% Open Area | | | |
| IPS 3.0 | 6.0 | 0.7 | 4.3 |
| 30% Open Area | | | |

As shown, the laminated shell provided very high pressure drop, but all of the perforated versions displayed greatly reduced pressure drop, indicating that perforated versions of the shell material would be suitable in a mask shell structure, combining adequate rigidity/strength with low pressure drop.

### Example 5: Combined Exterior Shell/Filter Insert Testing

A series of flat sheets comprising multiple layers of spunbond material and meltblown material from Example 1 in combination with the shell materials of Example 4 were tested using the same general testing protocol set forth in Example 2. Table 4 below provides the test data generated for various combinations.

TABLE 4

| | Face | Pressure | |
|---|---|---|---|
| Layers-Tested as | Velocity | Drop | Efficiency |
| stacked sheets | (cm/s) | (Pa) | (%) |
| S100-M30-S100 + No Shell | 6.0 | 78.3 | 99.93 |
| S100-M30-S100 + IPS | 6.0 | 82.6 | 99.93 |
| 1.0-4.9% Open Area | | | |
| S100-M30-S100 + IPS | 6.0 | 78.1 | 99.92 |
| 1.1-20% Open Area | | | |
| S100-M30-S100 + IPS | 6.0 | 78.7 | 99.18 |
| 3.0-30% Open Area | | | |
| S35 + M25 + S35 | 6.0 | 59.5 | 99.21 |
| S35 + M25 + S35 + IPS 1.0 | 6.0 | 64.6 | 99.14 |
| S35 + M25 + S100 | 6.0 | 66.4 | 99.77 |
| S35 + M25 + S100 + IPS 1.0 | 6.0 | 69.8 | 99.77 |
| S100 + M25 + S100 | 6.0 | 67.7 | 99.90 |
| S100 + M25 + S100 + IPS 1.0 | 6.0 | 72.1 | 99.91 |

The data demonstrate that perforated versions of the shell material do not impact filtration performance and the increase in pressure drop is negligible.

### Example 6: Filter Shell Durability

To assess the durability of the perforated shell material of Example 4, a sample of the IPS 1.0 material (4.9% open area) laminated material was subjected to multiple gentle laundry cycles with warm water and mild detergent, followed by tumble drying. After every five washing/drying cycles, the laundered material was subjected to the same testing protocol set forth in Example 2. Data from the testing is shown in Table 5 below.

TABLE 5

| | Velocity | Pressure | Efficiency |
|---|---|---|---|
| Structure Details | (cm/s) | (Pa) | (%) |
| Perforated Laminated | 6.0 | 6.50 | 6.50 |
| Double Layer | | | |
| Before Laundering | | | |
| Perforated Laminated | 6.0 | 7.60 | 6.25 |
| Double Layer | | | |
| 5 Cycles | | | |
| Perforated Laminated | 6.0 | 7.90 | 7.50 |
| Double Layer | | | |
| 10 Cycles | | | |
| Perforated Laminated | 6.0 | 8.35 | 8.85 |
| Double Layer | | | |
| 15 Cycles | | | |
| Perforated Laminated | 6.0 | 8.85 | 9.40 |
| Double Layer | | | |
| 20 Cycles | | | |
| Perforated Laminated | 6.0 | 9.70 | 7.90 |
| Double Layer | | | |
| 25 Cycles | | | |
| Perforated Laminated | 6.0 | 9.05 | 11.0 |
| Double Layer | | | |
| 30 Cycles | | | |

As shown above, the laundry cycles resulted in only minor changes in pressure drop and filtration efficiency, which suggests that the perforations did not greatly change in size after washing and drying. Visual inspection of the material also did not uncover significant deterioration of the material or the perforations. This testing suggests the perforated, laminated material is suitable for use as a reusable, washable shell material for a mask structure.

### Example 7: Quantitative Fit Testing

A mask comprising an exterior shell (two-layer laminated IPS 1.0 material from Example 4) and a filter inert (S35+M25+S100 material from Example 3) was constructed. The general dimensions of the exterior shell were 18 cm by 13 cm and the general dimensions of the filter insert were 11.5 cm by 17.6 cm. The exterior shell has loops on opposing sides for receiving an elastic head strap with cord lock.

The above mask structure was subjected to quantitative fit testing using a TSI PortaCount machine (TSI PortaCount 8048). The procedure followed OSHA Respiratory Protection Standard for Quantitative Fit Test (QNFT) Protocols (29 CFR 1910.134, Appendix A).

The resulting data for three subjects participating in the testing are shown in Table 6 below. As shown, the fit for all three subjects passed the test, showing that an embodiment of the mask structures of the present disclosure provides proper fit over the mouth and nose during various common activities. A fit factor of 100+ in the N95 mode is considered an excellent and acceptable fit factor.

TABLE 6

| | Normal | Deep | Side to | Up and | | | Bending | Normal | Pass |
|---|---|---|---|---|---|---|---|---|---|
| Subject | Breathing | Breathing | side | Down | Talking | Grimace | Over | Breathing | (Y/N) |
| A | 200+ | 200+ | 200+ | 200+ | 200+ | Excl. | 200+ | 200+ | Y |
| B | 200+ | 200+ | 200+ | 200+ | 200+ | Excl. | 200+ | 200+ | Y |
| C | 200+ | 200+ | 200+ | 200+ | 200+ | Excl. | 200+ | 200+ | Y |

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A mask comprising a perforated exterior shell sized to cover the nose and mouth of a user and constructed of one or more fabric layers, and a removable multi-layer nonwoven fabric insert sized to cover the nose and mouth of a user and adapted for abutting contact with the exterior shell, the nonwoven fabric comprising a layer of a spunbond material and a layer of meltblown material adjacent to the layer of spunbond material.

2. The mask of claim 1, wherein the nonwoven fabric further comprises a second layer of spunbond material adjacent to the layer of meltblown material on an opposing side thereof.

3. The mask of claim 2, wherein one or both of the layers of spunbond material comprise at least partially fibrillated bicomponent filaments formed from bicomponent filaments having an external fiber component and an internal fiber component, wherein the external fiber component at least partially enwraps the internal fiber component, and wherein the external fiber component is 5% to 25 wt. % of the bicomponent filament.

4. The mask of claim 3, wherein the internal fiber component and the external fiber component comprise different thermoplastic polymers selected from the list consisting of polyesters, polyamides, thermoplastic copolyetherester elastomers, polyolefins, polyacrylates, and thermoplastic liquid crystalline polymers.

5. The mask of claim 3, wherein the internal fiber component comprises a polyolefin such as polypropylene (PP) or polyethylene (PE) and the external fiber component comprises a polyester such as polylactic acid (PLA) or polyethylene terephthalate (PET), or the internal fiber component comprises a polyester such as polylactic acid (PLA) or polyethylene terephthalate (PET), and the external fiber component comprises a polyolefin such as polypropylene (PP) or polyethylene (PE).

6. The mask of claim 2, wherein each layer of spunbond material has a basis weight of about 20 to about 150 gsm and the mask has a combined spunbond basis weight of about 50 gsm or greater.

7. The mask of claim 6, wherein each layer of spunbond material has a basis weight of about 30 to about 120 gsm and the mask has a combined spunbond basis weight of about 100 gsm or greater.

8. The mask of claim 1, wherein the layer of meltblown nonwoven material has a basis weight of about 50 gsm or less.

9. The mask of of claim 1, wherein the multi-layer nonwoven fabric has no more than three layers of nonwoven material.

10. The mask of claim 9, wherein the multi-layer nonwoven fabric consists of two layers of the spunbond material, each layer of spunbond material having a basis weight of about 20 to about 120 gsm, and a layer of meltblown nonwoven material having a basis weight of about 50 gsm or less.

11. The mask of claim 1, wherein the layer of spunbond material is in abutting contact with the perforated exterior shell.

12. The mask of claim 1, wherein the perforated exterior shell comprises two or more fabric layers affixed together.

13. The mask of claim 12, wherein the perforated exterior shell comprises two fabric layers adhered together with a meltblown layer therebetween.

14. The mask of claim 1, wherein the perforated exterior shell comprises one or more layers of a woven or knitted fabric.

15. The mask of claim 1, wherein the perforations of the perforated exterior shell comprise about 4% or greater of the surface area of the perforated exterior shell.

16. The mask of claim 15, wherein the perforations of the perforated exterior shell comprise up to about 30% of the surface area of the perforated exterior shell.

17. The mask of of claim 1, wherein the mask has a filtration efficiency of about 95% or higher, measured according to the test set forth in 42 CFR Part 84 and NIOSH Procedure No. TEB-APR-STP-0059 at a face velocity of 10 cm/s.

18. The mask of of claim 1, wherein the mask has an initial pressure drop in the range of about 150 Pa or less measured according to the test set forth in 42 CFR Part 84 and NIOSH Procedure No. TEB-APR-STP-0059 at a face velocity of 10 cm/s.
